(19) United States
(12) Patent Application Publication
(10) Pub. No.: US 2023/0010102 A1
(43) Pub. Date: Jan. 12, 2023

(54) SYSTEMS AND METHODS FOR PAIRING WIRELESS POWER TRANSMITTERS AND RECEIVERS

(71) Applicant: WiTricity Corporation, Watertown, MA (US)

(72) Inventor: David Debaun, Westford, MA (US)

(21) Appl. No.: 17/853,061

(22) Filed: Jun. 29, 2022

Related U.S. Application Data
(60) Provisional application No. 63/216,766, filed on Jun. 30, 2021.

(51) Int. Cl. B60L 53/126; H02J 50/90; H02J 50/12; B60L 53/30

(52) U.S. Cl. CPC B60L 53/126; H02J 50/90; H02J 50/12; B60L 53/305; B60L 53/66

(57) ABSTRACT

Described herein are methods and system for pairing a wireless power receiver to a wireless power transmitter. The method can include joining, by the wireless power receiver, to a wireless network provided by a network device and transmitting, by the wireless power receiver over the wireless network, a message to a primary wireless power transmitter. The method can include receiving, by the wireless power receiver from the primary wireless power transmitter, identification information of an available communication channel and an SSID associated with an available transmitter. The method can include receiving, by the wireless power receiver over the wireless network, alignment information from the available transmitter associated with the SSID, detecting that the vehicle has parked proximate to the available wireless power transmitter according to the alignment information, and establishing, by the wireless power receiver with the available transmitter, a connection based on the SSID.

### CROSS-REFERENCE TO RELATED APPLICATIONS

This application claims priority to and the benefit of U.S. Provisional Patent Application No. 63/216,766 titled “SYSTEMS AND METHODS FOR PAIRING WIRELESS POWER TRANSMITTERS AND RECEIVERS” and filed on Jun. 30, 2021, the entirety of which is incorporated herein by reference.

### TECHNICAL FIELD

The following disclosure is directed to methods and systems for communication between wireless power transmitters and wireless power receivers and, more specifically, methods and systems for preventing communication issues among wireless power transmitters and receivers.

### BACKGROUND

Vehicles that have wireless power receivers may seek to park in parking spots enabled with wireless power transmitters. For instance, when such a vehicle approaches an area with two or more parking spots having transmitters, the receiver may not correctly or efficiently establish a connection with an available transmitter.

### SUMMARY

In general, in one aspect, a wireless power receiver configured to charge a battery of a vehicle is paired to a wireless power transmitter, by joining, by the wireless power receiver, to a wireless network provided by a network device; transmitting, by the wireless power receiver over the wireless network, a first message to a first wireless power transmitter; receiving, by the wireless power receiver over the wireless network, a network identifier; selecting, by the wireless power receiver, an available communication channel of one or more available communication channels; receiving, by the wireless power receiver over the wireless network, alignment information from an available one of a set of wireless power transmitters, the set comprising the first wireless power transmitter and at least a second wireless power transmitter; detecting that the vehicle has parked proximate to the available wireless power transmitter according to the alignment information; and establishing, by the wireless power receiver with the available wireless power transmitter, a connection based on the network identifier.

Implementations may include one or more of the following features, in any combination. The network identifier may be associated with the available wireless power transmitter. The network identifier may be received from the available wireless power transmitter. The first message may be transmitted to the first wireless power transmitter, wherein the first wireless power transmitter is in communication with at least the second wireless power transmitter. The network identifier may be received from the first wireless power transmitter. The network identifier may include a Service Set Identifier (SSID). The network identifier may include a Basic Service Set Identifier (BSSID). Selecting the available communication channel may include receiving, by the wireless power receiver over the wireless network, identification information of the available communication channel. The first message may be transmitted to the first wireless power transmitter, wherein the first wireless power transmitter is in communication with at least the second wireless power transmitter, and the identification information of the available communication channel may be received from the first wireless power transmitter. The wireless power receiver may transmit a request to connect to the available wireless power transmitter. The first message may be a broadcast message to a set of wireless power devices, the set including at least the first and second wireless power transmitters. The set of wireless power devices may include at least one other wireless power receiver in communication with one of the at least two wireless power transmitters, and the wireless power receiver may also receive identification information of one or more communication channels in use by the other wireless power receiver. The first message may be a broadcast message. The transmitted message may be a direct message to a specific device on the wireless network. At least one other wireless power receiver may be joined to the wireless network. The detecting may be by the wireless power receiver or by a component coupled to the wireless power receiver. The wireless power receiver may disconnect from the wireless network. The network device may include a router associated with a residence. The network device further may include a Wi-Fi access point. The network device further may include an LTE modem.

In general, in one aspect, a wireless power receiver configured to charge a battery of a vehicle includes a network interface, and a processor which is configured to connect the wireless power receiver to a wireless power transmitter by joining the network interface to a wireless network provided by a network device; transmitting, over the wireless network, a first message to a first wireless power transmitter; receiving, over the wireless network, a network identifier; selecting an available communication channel of one or more available communication channels; receiving, over the wireless network, alignment information from an available one of a set of wireless power transmitters, the set comprising the first wireless power transmitter and a at least a second wireless power transmitter; detecting that the vehicle has parked proximate to the available wireless power transmitter according to the alignment information; and establishing, with the available wireless power transmitter, a connection based on the network identifier.

In general, in one aspect, a wireless power transmitter includes a network interface, and a processor which is configured to connect the wireless power transmitter to a wireless power receiver configured to charge a battery of a vehicle by joining the network interface to a wireless network provided by a network device; establishing communication with at least one secondary wireless power transmitter over the wireless network; receiving, over the wireless network, a first message from a first wireless power receiver; transmitting, over the wireless network, a network identifier to the wireless power receiver; when the wireless transmitter is an available wireless power transmitter, transmitting, over wireless network, alignment information to enable the wireless power receiver to detect that the vehicle has parked proximate to the wireless power transmitter; establishing, with the wireless power receiver, a connection based on the network identifier.

In one aspect, the disclosure features pairing a wireless power receiver to a wireless power transmitter. The wireless power receiver can be configured to charge a battery of a vehicle. The wireless power receiver can join a wireless network provided by a network device and can transmitting, over the wireless network, a message to a primary wireless power transmitter. The primary wireless power transmitter can be in communication with at least one secondary wireless power transmitter. The wireless power receiver can receive identification information of an available communication channel and a network identifier, such as a Service Set Identifier (SSID), from the primary wireless power transmitter. The network identifier can be associated with an available one of a set of wireless power transmitters. The set can include the primary wireless power transmitter and the at least one secondary wireless power transmitter. The wireless power receiver can receive alignment information from the available wireless power transmitter associated with the network identifier over the wireless network, detect that the vehicle has parked proximate to the available wireless power transmitter according to the alignment information, and establish, with the available wireless power transmitter, a connection based on the network identifier.

In another aspect, the disclosure features a method for pairing a wireless power receiver to a wireless power transmitter. The wireless power receiver can be configured to charge a battery of a vehicle. The method can include joining, by the wireless power receiver, to a wireless network provided by a network device, and transmitting, by the wireless power receiver over the wireless network, a message to a primary wireless power transmitter. The primary wireless power transmitter can be in communication with at least one secondary wireless power transmitter. The method can include receiving, by the wireless power receiver from the primary wireless power transmitter, identification information of an available communication channel, and receiving, by the wireless power receiver over wireless network, alignment information from an available wireless power transmitter. The method can include detecting that the vehicle has parked proximate to the available wireless power transmitter according to the alignment information, and transmitting, by the wireless power receiver, a request to connect to the available wireless power transmitter. The method can include receiving, by the wireless power receiver, a message from the available wireless power transmitter, the message comprising a network identifier; and establishing, by the wireless power receiver with the available wireless power transmitter, a connection based on the network identifier.

In another aspect, the disclosure features a method for pairing a wireless power receiver to a wireless power transmitter. The wireless power receiver can be configured to charge a battery of a vehicle. The method can include joining, by the wireless power receiver, to a wireless network provided by a network device, and transmitting, by the wireless power receiver over the wireless network, a broadcast message to a set of wireless power devices, the set including at least two wireless power transmitters. The method can include selecting, by the wireless power receiver, an available communication channel of the one or more available communication channels, receiving, by the wireless power receiver over the wireless network, alignment information from an available wireless power transmitter, and detecting that the vehicle has parked proximate to the available wireless power transmitter according to the alignment information. The method can include transmitting, by the wireless power receiver, a request to connect to the available wireless power transmitter, receiving, by the wireless power receiver, a message from the available wireless power transmitter, the message comprising a network identifier, and establishing, by the wireless power receiver with the available wireless power transmitter, a connection based on the network identifier.

Various embodiments can include one or more the following features, in any combination.

The set can include at least one other wireless power receiver in communication with one of the at least two wireless power transmitters over a communication channel. The method can further include receiving, by the wireless power receiver, identification information of one or more communication channels in use by the other wireless power receiver. The two or more wireless power transmitters can be joined to the wireless network. The detecting can be by the wireless power receiver or by a component coupled to the wireless power receiver. The method can include disconnecting, by the wireless power receiver, from the wireless network. The network device can be a router associated with a residence. The network device can be a Wi-Fi access point. The network device can be an LTE modem.

### BRIEF DESCRIPTION OF THE DRAWINGS

FIG. 1 is a block diagram of an exemplary wireless power system.

FIG. 2 is a diagram of an example vehicle charging environment including a parking facility with multiple wireless charging stations for use by vehicles.

FIG. 3 is a diagram of an example sequence for connecting a vehicle assembly (VA) of an approaching vehicle to a ground assembly (GA) of a set of GAs of FIG. 2.

FIG. 4 is a flowchart of an example method for connecting the VA of the approaching vehicle to the GA of a set of GAs according to the sequence of FIG. 3.

FIG. 5 is a diagram of an example vehicle charging environment including a parking facility with multiple wireless charging stations for use by vehicles.

FIG. 6 is a diagram of an example sequence for connecting a VA of an approaching vehicle to a GA of a set of GAs of FIG. 5.

FIG. 7 is a flowchart of an example method for connecting the VA of the approaching vehicle to the GA of a set of GAs according to the sequence of FIG. 6.

FIG. 8 is an example sequence for connecting a VA of an approaching vehicle to a GA of a set of GAs of FIG. 5.

FIG. 9 is a flowchart of an example method for connecting the VA of the approaching vehicle to the GA of a set of GAs according to the sequence of FIG. 8.

FIG. 10 is a block diagram of an example computer system that may be used in implementing the systems and methods described herein.

### DETAILED DESCRIPTION

Disclosed herein are exemplary embodiments of systems and methods for protecting component(s) of a wireless power system. In particular, the exemplary systems and methods can protect component(s) of a wireless power receiver from an over-voltage condition due to a decrease in the auxiliary power used to supply circuitry that controls the component(s).

Wireless Power Systems

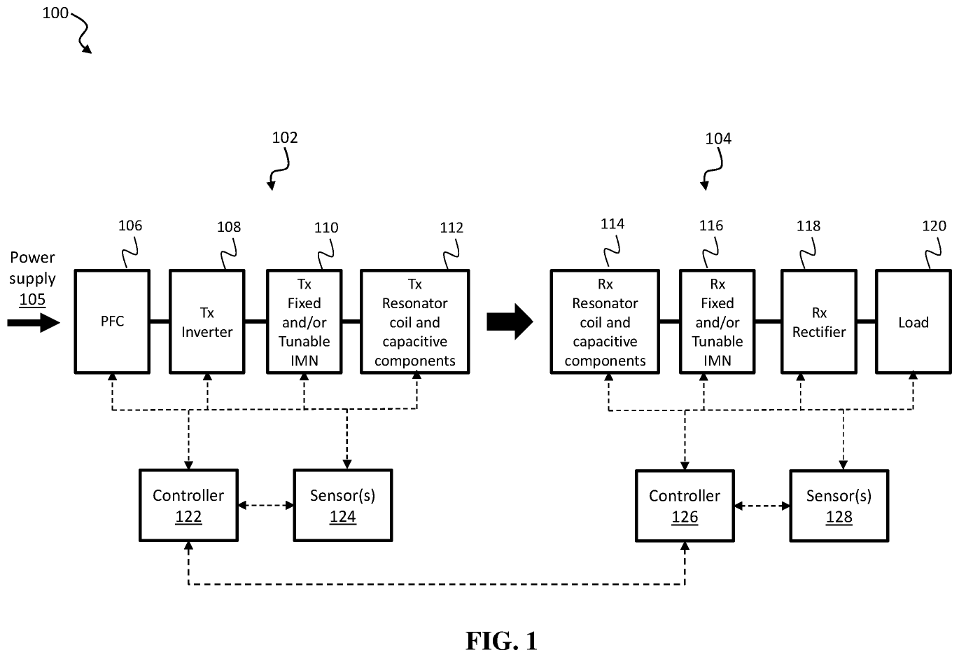

FIG. 1 is a block diagram of an exemplary wireless power system 100 including the exemplary system for auxiliary power dropout protection. The system 100 includes a wireless power transmitter 102 and a wireless power receiver 104. In transmitter 104, a power supply 105 (e.g., AC mains, battery, etc.) provides power to an inverter 108. Additional components can include power factor correction (PFC) circuit 106 before the inverter stage 108. The inverter 108 drives the transmitter resonator coil and capacitive components 112 (“resonator”), via an impedance matching network 110 (including fixed or tunable network components). The resonator 112 produces an oscillating magnetic field which induces a current or voltage in receiver resonator 114. The received energy is provided to a rectifier 118 via impedance matching network 116 (including fixed or tunable network components). Ultimately, the rectified power is provided to a load 120 (e.g., one or more batteries of an electric or hybrid vehicle). In some embodiments, the battery voltage level can impact various parameters (e.g., impedance) of the wireless power system 100. Therefore, the battery voltage level may be received, determined, or measured to be provided as input to other portions of the wireless power system 100. For example, typical battery voltage ranges for electric vehicles include 280 V-420 V, etc.

In some embodiments, one or more components of the transmitter 102 can be coupled to a controller 122, which may include a communication module (e.g., Wi-Fi, radio, Bluetooth, in-band signaling mechanism, etc.). In some embodiments, one or more components of the transmitter 102 can be coupled to one or more sensors 124 (e.g., current sensor(s), voltage sensor(s), power sensor(s), temperature sensor(s), fault sensor(s), etc.). The controller 122 and sensor(s) 124 can be operably coupled to control portions of the transmitter 102 based on feedback signals from the sensor(s) 124 and sensor(s) 128.

In some embodiments, one or more components of the receiver 104 can be coupled to a controller 126, which may include a communication module (e.g., Wi-Fi, radio, Bluetooth, in-band signaling mechanism, etc.). In some embodiments, one or more components of the transmitter 102 can be coupled to one or more sensors 128 (e.g., current sensor(s), voltage sensor(s), power sensor(s), temperature sensor(s), fault sensor(s), etc.). The controller 126 and sensor(s) 128 can be operably coupled to control portions of the transmitter 102 based on feedback signals from the sensor(s) 124 and sensor(s) 128.

Examples of wireless power systems can be found in U.S. Pat. No. 8,461,719 titled “Wireless energy transfer systems,” and U.S. Pat. No. 8,933,594 titled “Wireless energy transfer for vehicles,” both of which are hereby incorporated by reference in their entireties.

In some embodiments, the exemplary impedance matching networks 110, 116 can include one or more variable impedance components. The one or more variable impedance components may be referred together herein as a “tunable matching network” (TMN). TMNs can be used in adjusting the impedance (e.g., including the reactance) of the wireless power transmitter 102 or receiver 104. In some embodiments, tunable matching network(s) may be referred to as “tunable reactance circuit(s)”. In some applications, e.g., wireless power transmission, impedances seen by the wireless power transmitter 102 and receiver 104 may vary dynamically. In such applications, impedance matching between a receiver resonator coil (of 114) and a load 120, and a transmitter resonator coil (of 112) and the inverter 108, may be required to prevent unnecessary energy losses and excess heat.

The impedance experienced by a resonator coil may be dynamic, in which case, a dynamic impedance matching network can be provided to match the varying impedance to improve the performance (e.g., efficiency, power delivery, etc.) of the system 100. In the case of the power supply 105 in a wireless power system 100, the impedances loading the inverter 108 may be highly variable because of changes in the load 120 receiving power (e.g., battery or battery charging circuitry) and changes in the coupling between the transmitter 102 and receiver 104 (caused, for example, by changes in the relative position of the transmitter and receiver resonator coils). Similarly, the impedance loading the receiver resonator 114 may also change dynamically because of changes in the load 120 receiving power. In addition, the desired impedance matching for the receiver resonator 114 may be different for different coupling conditions or power supply conditions.

Accordingly, power transmission systems transmitting or receiving power via highly resonant wireless power transfer, for example, may be required to configure or modify impedance matching networks 110, 116 to maintain efficient power transmission. One or more components of the TMN can be configured to present an impedance between a minimum impedance and a maximum impedance attainable by the particular components. In various embodiments, the attainable impedance can be dependent on the operating frequency (e.g., 80 kHz to 90 kHz) of the wireless power system 100. This configuration may be performed continuously, intermittently, or at certain points in power transmission (e.g., at the beginning of power transmission). Examples of tunable matching networks can be found in U.S. Patent Application Publication No. 2017/0217325, published Aug. 3, 2017 and titled “Controlling Wireless Power Transfer Systems,” and U.S. Patent Application Publication No. 2017/0229917, published Aug. 10, 2017 and titled “PWM Capacitor Control,” both of which are hereby incorporated by reference in their entireties.

High-power wireless power transmitters can be configured to transmit wireless power in applications such as powering of or charging a battery of vehicles, industrial machines, robots, or electronic devices relying on high power. For the purpose of illustration, the following disclosure focuses on wireless power transmission for vehicles (e.g., electric vehicles, hybrid vehicles, etc.). However, it is understood that any one or more of the embodiments described herein can be applied to other applications in which wireless power can be utilized.

Connections Between Wireless Power Transmitters and Wireless Power Receivers

One aspect of wireless charging (e.g., of vehicles) to be addressed is establishing network communications between a wireless power receiver of the vehicle and the wireless power transmitter proximate to which the vehicle is parked. This establishment of network communications may be challenging in a residential setting with multiple wireless power transmitters at which multiple vehicles may be attempting to park at the same time or near the same time. In some cases, the example connection methods and systems discussed herein are beneficial for residential settings (e.g., a house, a condominium, apartment building, a multi-unit residence, etc.) having two or more wireless power transmitters. However, it is understood that one or more of the connection methods and systems may be used in commercial settings (e.g., a shopping mall, office, government building, school, etc.) having two or more wireless power transmitters. In some embodiments, the example connection methods and systems implemented in a commercial setting can include one or more security features including, e.g., an authentication step before initiating connection.

Wireless charging for residential settings may be considered a “private” use while wireless charging for commercial settings may be considered a “public” use. As discussed herein, a wireless power transmitter may be referred to as a “ground assembly” or “GA” and a wireless power receiver may be referred to as a “vehicle assembly” or “VA”.

As an example of one particular problem, a VA may establish network communications with a GA in an adjacent parking spot, determining that it has established communication with the correct wireless charging station in its own parking spot. When the VA requests power and does not receive it (because it is in communication with the wrong GA), the VA may not detect the source of the problem. Likewise, the GA in the adjacent parking spot may detect a fault because it is providing power and recognizing no load (e.g., of the vehicle). This problem may be referred to as “cross-connect.” In addition to the primary function of providing power being compromised in a cross-connect situation, additional features (e.g., vehicle alignment guidance) and safety features (e.g., foreign object detection, living object detection, etc.) may not operate properly, if at all, when communications are not established between the VA and the correct GA.

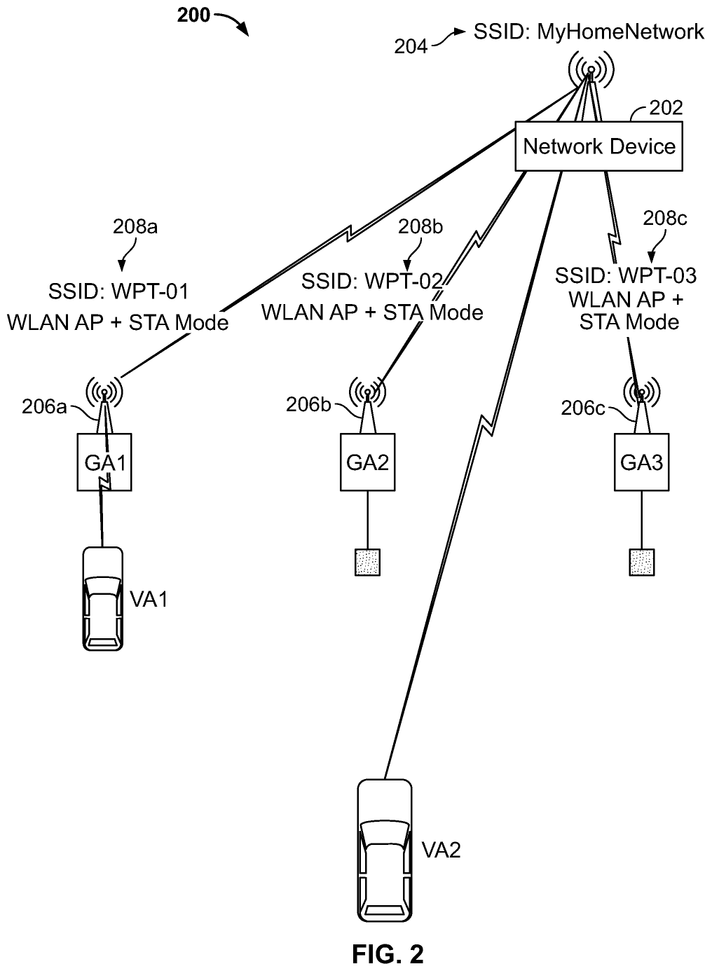

FIG. 2 illustrates an example vehicle charging environment 200 including a parking facility with multiple wireless charging stations for use by vehicles. The environment 200 may be part of or adjacent to a residence. As shown in the illustrated example, multiple GAs (e.g., GA1, GA2, GA3) are in communication with a network device 202. The network device 202 may include a router, an access point, or a switch. Any suitable number of GAs can be implemented. The network device 202 provides, or is in communication with, a first wireless network 204 with a network Service Set Identifier (SSID) (e.g., “MyHomeNetwork”). For example, the network device 202 may be a home router with an integrated Wi-Fi access point associated with a household (e.g., of a driver of one or more VAs). In another example, the network may be provided by a wireless access point that may be a stand-alone device or part of other network infrastructure in communication with the network device 202 through other mechanisms, including a wired network or an internal data bus. While Wi-Fi (IEEE 802.11) can be used in the environment 200 and generally herein as an example communication standard used for illustration, other network physical layers and higher-level protocols may also or instead be used, e.g., Bluetooth® or IEEE 802.15.4 (low-rate wireless networks, e.g., ZigBee®).

Each of the GAs (e.g., GA1, GA2, GA3) has a wireless network interface 206 (e.g., wireless network interfaces 206a, 206b, 206c, respectively), which can be configured to function as a wireless access point for its own private network 208 (e.g., 208a, 208b, 208c, respectively), indicated by network SSID names corresponding to the station's number: GA1 broadcasts a private network 208a with the network SSID WPT_01, GA2 broadcasts another private network 208b with the SSID WPT_02, and GA3 broadcasts another private network 208c with the SSID WPT_03. In some examples, rather than using the SSID to identify the network interfaces, a Basic Service Set Identifier (BSSID) can be used. The BSSID may consist of the MAC access of the network interface, and allows a client to connect directly to the network interface without needing the SSID of the wireless network it provides. Any references to SSID below should be understood to mean any applicable network identifier, including SSID and BSSID. In some aspects, the GAs can communicate with the network device 202 over a network interface other than the wireless network interface 206. In the example scenario depicted in FIG. 2, GA1 is already connected to VA1 and using its own wireless network 208a to communicate with the VA1. The other wireless charging stations (e.g., GA2 and GA3) can use their respective network interfaces 206b, 206c to communicate with the network device 202 over the wireless network 204 with the network SSID MyHomeNetwork. In the example scenario of FIG. 2, a vehicle having a vehicle assembly VA2 may approach the parking environment 200 having two or more GAs in a search for a place to park and charge. In some embodiments, an approaching VA is more at risk of the cross-connect issues described above when there are one or more VAs connected to the wireless network 204 and approaching GAs in the environment 200. In some cases, a VA that is already connected to a GA poses less of a cross-connect issue because it is typically at the end of the pairing process and over the GA.

The following describes various systems and methods for VA-to-GA pairing while avoiding the cross-connect issues described above. Note that the GAs, VAs, or the network device can be configured to pair in at least one of the methods described below. The GAs, VAs, or the network device 202 can be configured at the time of install in the environment 200 (e.g., by a technician), also referred to as “an install-time configuration”. In some embodiments, it is more efficient for the GAs, VAs, or network device to have one default configuration that requires little or no action (e.g., additional settings, change in configuration, etc.) by the installer at time of installation, but still provides flexibility to make a configuration change during installation if needed depending on the networking situation. In some embodiments, if the home Wi-Fi coverage does not reach the garage (where the GA would be physically located), one GA could assume the role of the router as the primary access point and receive connections from other GAs and VAs. The primary GA could provide internet access through an LTE connection (e.g., USB-cellular modem). This would be an example of a different network configuration (as compared to a default network configuration) that could be made at install time.

Distributed Table Methods

In an example method for pairing VAs to GAs, the system is characterized by a distributed passive beacon (PB) channel selection and VA-to-VA communication. In this method, there is a significant use of broadcasts to accomplish pairing. The GAs or VAs can be connected to a network device 202 (e.g., a router, a home Wi-Fi access point, a common area Wi-Fi access point for two or more residential units, etc.). For instance, if network device 202 is a Wi-Fi access point, it can continuously broadcast its SSID (e.g., “MyHomeNetwork”) and allow connections from GAs or VAs upon authentication, e.g., via a password or biometric input. The GAs can be configured to be in Wi-Fi access point (AP) mode and station (STA) mode simultaneously. In particular, the GAs can be connected to the Wi-Fi network 204 as stations and broadcast their own networks in hidden AP mode. These modes can be based on the configuration of the GA at the time of install in the environment 200 (e.g., by a technician), also referred to as “an install-time configuration”.

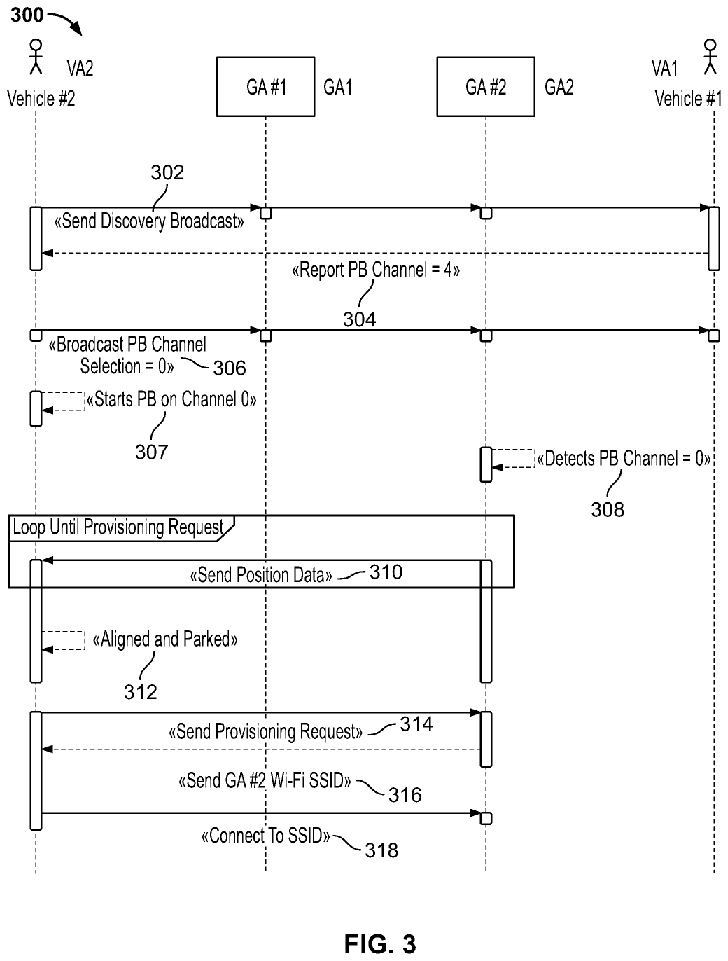

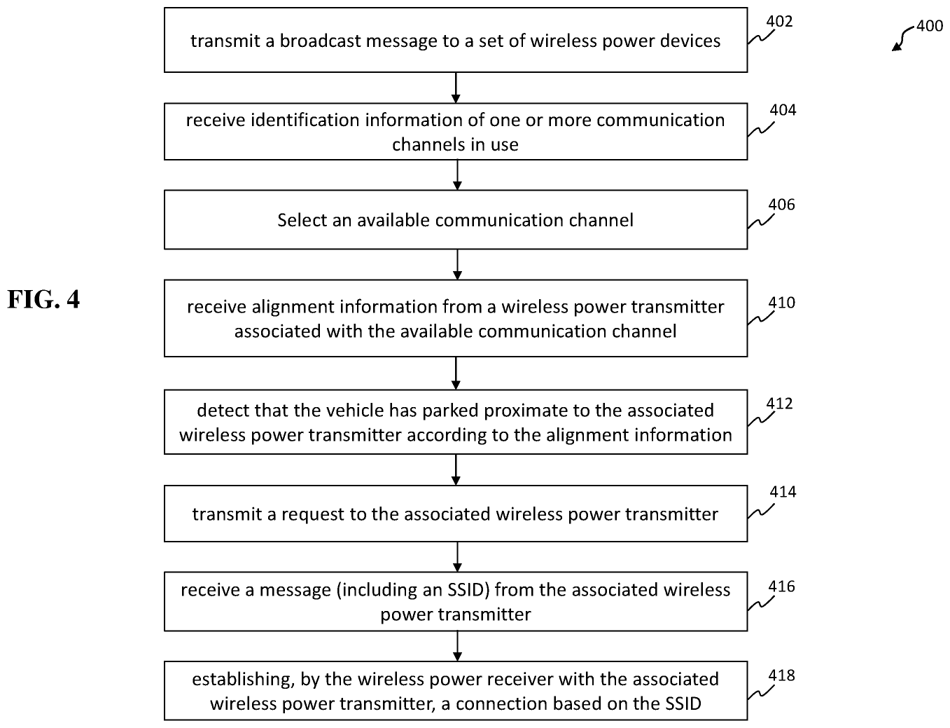

FIG. 3 provides an example sequence 300 for connecting a VA of an approaching vehicle to a GA of a set of GAs (refer to FIG. 2). FIG. 4 provides an example method 400 for connecting the VA of the approaching vehicle to the GA of a set of GAs according to the sequence 300. FIGS. 3 and 4 are discussed together herein for clarity and conciseness.

A VA of an approaching vehicle can connect to the Wi-Fi network 204 based on an install-time configuration. In process 302 (step 402), the approaching VA may send a UDP broadcast message (also referred to as a “discovery broadcast”) to the VAs or GAs connected to the network 204. The broadcast message can request the identities of any PB channels in use at the time the VA has approached the wireless network 204 (e.g., within a particular radius of the Wi-Fi access point). For example, the radius at which the VA may initiate a connection with the network and start the PB channel discovery or selection process can be 50 meters or less, 40 meters or less, 30 meters or less, 20 meters or less, etc. The broadcast message can be configured such that non-GA and non-VA devices will ignore this message because it will not carry meaning for them. For instance, the UDP message structure will be unrecognizable to recipient devices that are not GAs or VAs. Because UDP does not require a response or acknowledgement from the recipient, those other devices simply ignore the broadcast. Accordingly, by using this approach, the broadcast message is not expected to interfere with any other devices because they will likely filter out the message.

In process 304 (step 404), if there are any other VAs connected to the network 204 at the time the approaching VA sends its message, the other VAs can reply with a message including information related to the PB channel the respective other VA is using. VA2 may receive the message from the other VAs (e.g., VA1). Note that, if there are no other VAs, VA2 can proceed to the next process/step.

In process 306 (step 406), the approaching VA can select an available channel from a predetermined list of available PB channels (e.g., valid PB channels). A valid PB channel may include channels associated with one or more frequencies that are producible by the VA's PB technology and detectable by the GA's sensing technology (e.g., living object detection (LOD), foreign object detection (FOD), position detection, multi-object detection system (MODS) sensing technology). The approaching VA sends a UDP broadcast message that includes its selected PB channel to VAs or GAs connected to the network 204. Note that, if there is only one available PB channel to select from, the VA1 is configured to select the lone available channel. In process 307, VA2 starts its PB on the selected channel.

In process 308, the GA (in this example, GA2) detects the broadcast message including the selected PB channel.

In process 310 (step 410), the selected GA2 starts sending UDP messages to the VA2 via the network. The messages can include positioning data collected by the GA2 to help the vehicle having VA2 align properly over the GA2. In some cases, if the assigned PB is not received at any GA within a specified time (e.g., 10 seconds, 30 seconds, 1 minute, etc.), the VA2 disconnects itself from the network and stops PB operation. Process 310 can proceed (e.g., in a loop) until alignment is complete and the vehicle is put in park (during process 312 and step 412). In particular, the vehicle is parked proximate to the GA2 (e.g., over the GA2) such that the VA is aligned to the GA for efficient power reception.

In process 314 (step 414), the VA2 sends a UDP request via the network 204 to the GA2 to start the provisioning process. The provisioning process can include the process of the VA connecting to the GA's own network 208 (e.g., each time, including the first time). In some embodiments, the sequence 300 (method 400) can rely on the VA storing the router's credentials between each charging session. Accordingly, the provisioning process (including the exchange of GA's SSID and VA's connection to that SSID) can happen each time the VA approaches.

In process 316 (step 416), the GA2 responds by sending the VA2 (via the network) a UDP message with the GA's SSID.

In process 318 (step 418), the VA2 connects to the GA2 directly based on the GA's SSID. In some embodiments, the VA is momentarily connected as a STA on two different network interfaces to both the wireless network 204 AP and the GA's AP until the VA verifies the GA connection and can drop the connection to the wireless network 204. In another embodiment, the VA remains connected to the wireless network 204 (or, as described for the Centralized Table Methods below, a single primary GA AP) throughout charging, which requires two “hops” between the VA and the GA (e.g., a first hop between the VA and the router and the second hop between the router and the GA) instead of a direct connection between VA and GA.

In some embodiments, once the VA2 connects to GA2, VA2 may disconnect its Wi-Fi connection with the network 204. In some embodiments, the GA2 stops responding to discovery broadcasts from other VAs until the end of the current charging session with VA2. In some embodiments, once the direct Wi-Fi connection between GA and VA has been established, a charging-related communication protocol (e.g., SAE J2847/6) may be used to perform a second pairing validation sequence. Pairing may be completed with or without the second pairing validation sequence.

Centralized Table Methods—Type I

In an example method for pairing VAs to GAs, the system is characterized by centralized management of PB channel assignments. In this example method, there may be less reliance on broadcasts (e.g., by the VAs or GAs). Further, as described further below, each GA may be designated as a primary or a secondary device.

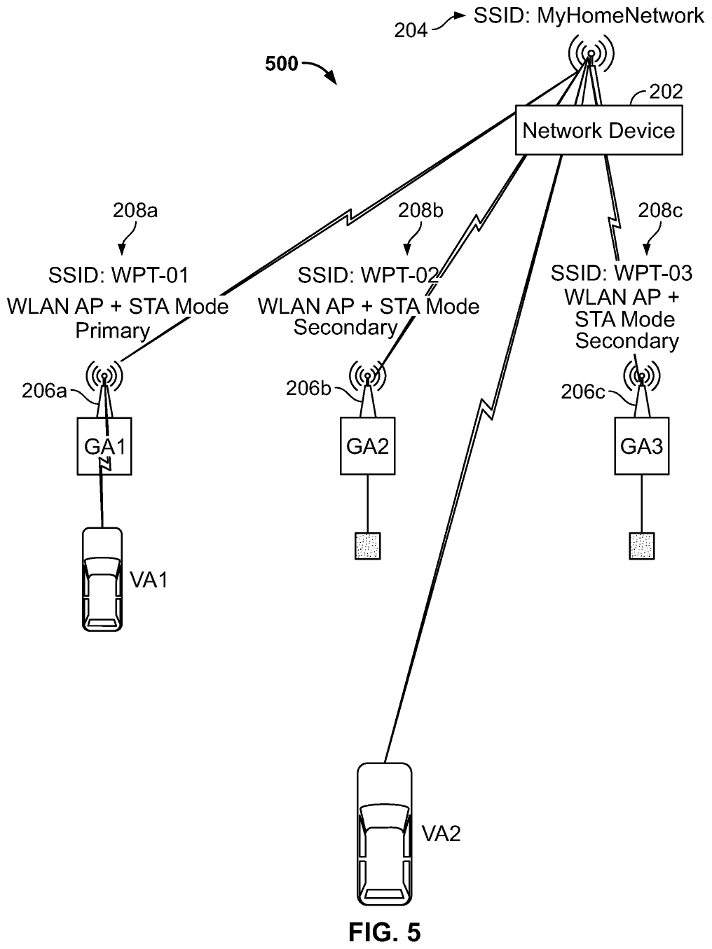

FIG. 5 illustrates an example vehicle charging environment 500 including a parking facility with multiple wireless charging stations for use by vehicles. The network device 202 (e.g., a Wi-Fi access point) can continuously broadcast its SSID (e.g., “MyHomeNetwork”) and allow connections from GAs or VAs upon authentication, e.g., via a password or biometric input. The GAs can be configured to be in Wi-Fi access point (AP) mode and station (STA) mode simultaneously. In particular, the GAs can be connected to the network 204 as stations and broadcast their own networks in hidden AP mode. These modes can be based on an install-time configuration. In environment 500 at installation, one GA is assigned “primary” (e.g., GA1) and other GAs are assigned “secondary” (e.g., GA2 and GA3). The primary GA is configured to maintain two tables (e.g., in a memory module). One table can include information associated with the connected VAs and their respective PB channels in use. The other table can include information associated with the connected GAs and their respective IP addresses or other network identifiers, e.g., hostnames or MAC addresses.

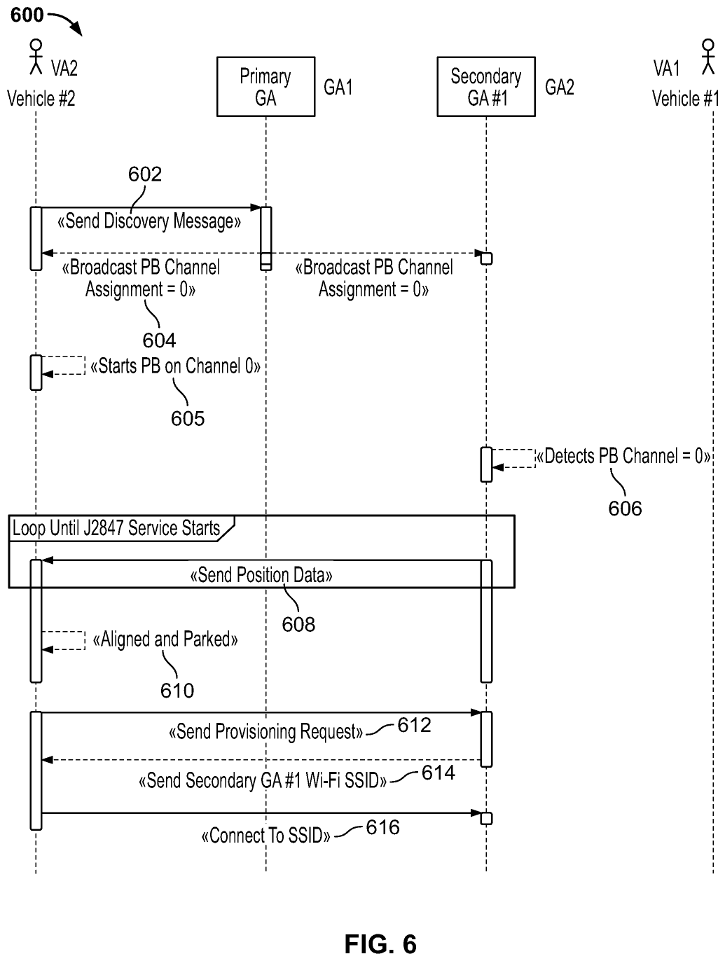

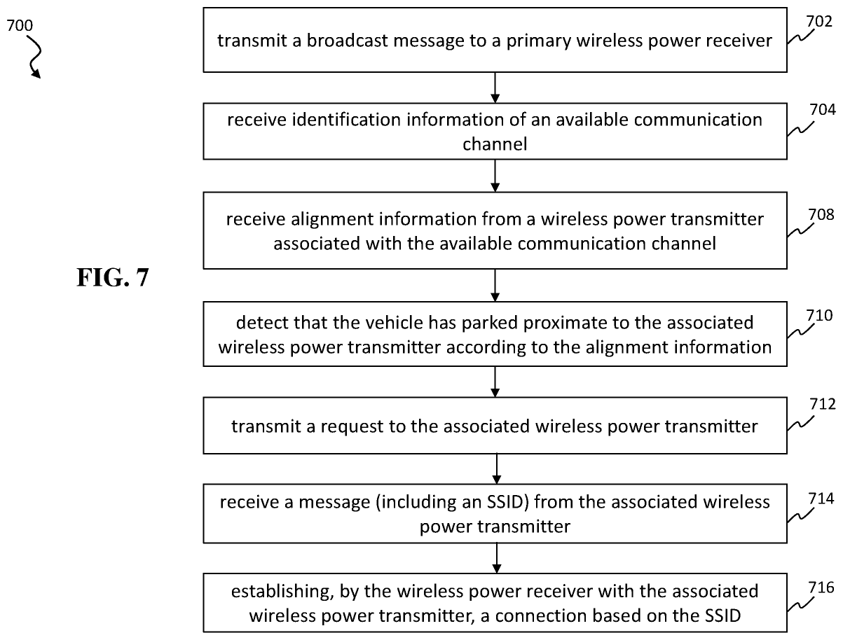

FIG. 6 provides an example sequence 600 for connecting a VA of an approaching vehicle to a GA of a set of GAs (refer to FIG. 5). FIG. 7 provides an example method 700 for connecting the VA of the approaching vehicle to the GA of a set of GAs according to the sequence 600. FIGS. 6 and 7 are discussed together herein for clarity and conciseness.

A VA of an approaching vehicle can connect to the Wi-Fi network 204 based on an install-time configuration. In process 602 (step 702), the approaching VA (e.g., VA2) is configured to send a message to the primary GA. In some embodiments, the VA2 can send the message to the primary GA at a pre-known address to request a PB channel. In some embodiments, the VA2 can send a “discovery message” in the form of a broadcast message to the wireless network 500 (instead of a single pre-known address) to which the primary GA can respond and reveal its IP address or other identifier.

In process 604 (step 704), the primary GA is configured to respond with a UDP message assigning the next available PB channel to the VA2 based on a predetermined list of valid PB channels. The message can be a broadcast message that is configured to announce the assignment to the GAs in environment 500. In some cases, the primary GA's message can include the VA's IP address or other identifier to avoid ambiguity if multiple vehicles (having VAs) approach simultaneously. In process 605, the VA2 can initiate its PB on the channel assigned by the primary GA.

In process 606, the GA2 can detect the assigned PB channel.

In process 608 (step 708), once a GA receives VA2's PB, that GA (e.g., GA2) can start sending UDP messages to the VA2 associated with that PB channel through the network 204. The messages can include positioning data collected by the GA to help the vehicle align properly over the GA. In some cases, if no PB using the assigned channel is received at any GA, such that the VA2 does not receive the UDP messages of process 608 within a specified time (e.g., 10 seconds, 30 seconds, 1 minute, etc.), the VA2 can disconnect itself from the wireless network and stop PB operation. Process 608 can proceed (e.g., in a loop) until alignment is complete and the vehicle is put in park (during process 610 and step 710). In particular, the vehicle is parked proximate to the GA2 (e.g., over the GA2) such that the VA is aligned to the GA for efficient power reception.

In process 612 (step 712), the VA can be configured to send a UDP request directly to the secondary GA (i.e., GA2) to start the provisioning process.

In process 614 (step 714), the GA2 can respond by sending VA2 a UDP message with GA2's SSID.

In process 616 (step 716), the VA2 can connect to the GA directly based on its SSID, e.g., via simultaneous STA/STA mode.

In some embodiments, the VA2 can subsequently disconnect its Wi-Fi connection with the wireless network 204. In some embodiments, the GA2 can stop responding to discovery broadcasts from other approaching VAs until the end of the charging session with VA2. In some embodiments, once the direct Wi-Fi connection between GA and VA has been established, a charging-related communication protocol (e.g., SAE J2847/6) can be used to perform a second pairing validation sequence. Pairing may be completed with or without the second pairing validation sequence.

Centralized Table Methods—Type II

In an example method for pairing VAs to GAs, the system is characterized by centralized management of PB channel assignments. In this example method, there are no broadcasts (e.g., by the VAs or GAs), which has the advantage of minimizing communication traffic on the network. Further, as described further below, each GA may be designated as a primary or a secondary device. Note that the example methods and systems for pairing VAs to GAs within this section refers to the example vehicle charging environment of FIG. 5.

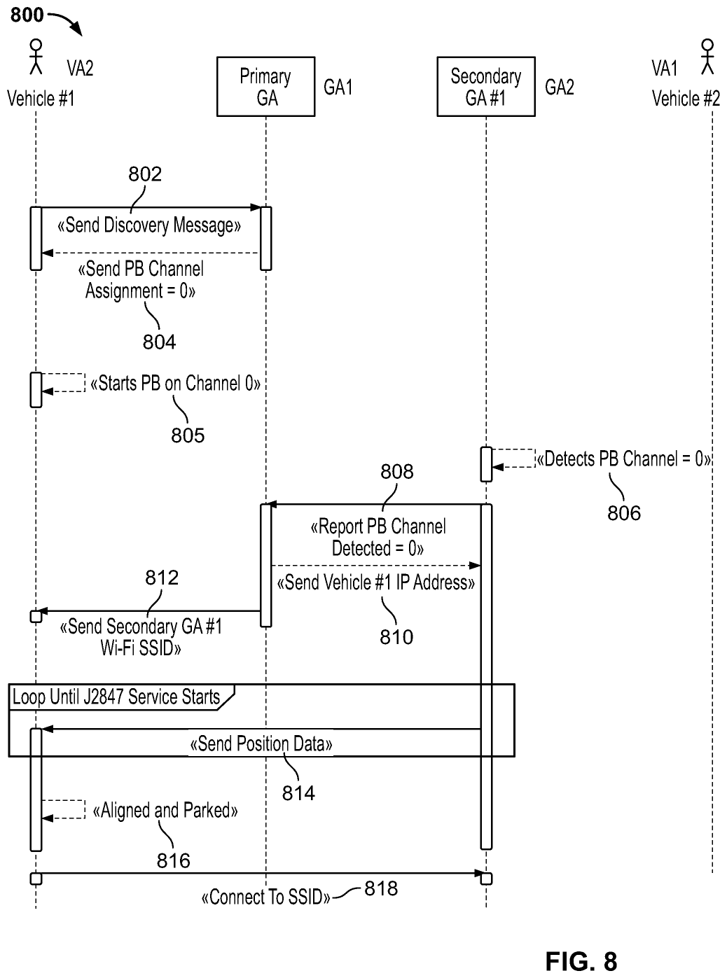

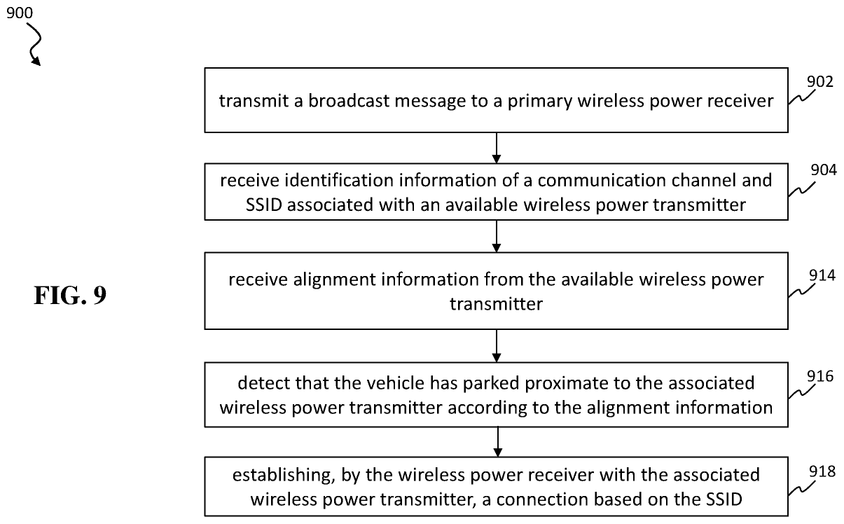

FIG. 8 provides an example sequence 800 for connecting a VA of an approaching vehicle to a GA of a set of GAs (refer to FIG. 5). FIG. 9 provides an example method 900 for connecting the VA of the approaching vehicle to the GA of a set of GAs according to the sequence 800. FIGS. 8 and 9 are discussed together herein for clarity and conciseness.

A VA of an approaching vehicle can connect to the Wi-Fi network 204 based on an install-time configuration. In process 802 (step 902), the approaching VA (e.g., VA2) is configured to send a message to the primary GA. In some embodiments, the VA2 can send the message to the primary GA at a pre-known address to request a PB channel. In some embodiments, the VA2 can send a “discovery message” in the form of a broadcast message to the network (instead of a single pre-known IP address) to which the primary GA can respond and reveal its IP address.

In process 804 (step 904), the primary GA is configured to respond with a UDP message assigning the next available PB channel to the VA2 based on a predetermined list of valid PB channels. In some cases, the primary GA's message can include the VA's IP address to avoid ambiguity if multiple vehicles (having VAs) approach simultaneously. In process 805, the VA2 initiates its PB on the channel assigned by the primary GA.

In process 806, the GA2 detects the PB using the assigned channel.

In process 808, once a GA receives VA2's PB, that GA (e.g., GA2) sends a message to the primary GA (e.g., GA1) indicating that the GA detected the PB using the assigned channel.

In process 810, the primary GA responds to the detecting GA (GA2) with the IP address or other identifier of the approaching VA2.

In process 812, the primary sends the Wi-Fi SSID of the detecting GA (GA2) to the approaching VA (VA2). In some cases, if no PB using the assigned channel is received at any GA, such that the VA2 does not receive the SSID of a secondary GA via process 812 within a specified time (e.g., 10 seconds, 30 seconds, 1 minute, etc.), the VA2 disconnects itself from the network and stops PB operation.

In process 814 (step 914), the detecting GA (GA2) starts sending UDP messages to the VA2 associated with that PB channel through the network 204. The messages can include positioning data collected by the GA to help the vehicle align properly over the GA. Process 814 can proceed (e.g., in a loop) until alignment is complete and the vehicle is put in park (during process 816 and step 916). In particular, the vehicle is parked proximate to the GA2 (e.g., over the GA2) such that the VA is aligned to the GA for efficient power reception.

In process 818 (step 918), the VA2 connects to the GA directly based on its SSID.

In some embodiments, the VA2 subsequently disconnects its Wi-Fi connection with the network 204. In some embodiments, the GA2 stops responding to discovery messages from other approaching VAs until the end of the charging session with VA2. In some embodiments, once the direct Wi-Fi connection between GA and VA has been established, a charging-related communication protocol (e.g., SAE J2847/6) is used to perform a second pairing validation sequence. Pairing may be completed with or without the second pairing validation sequence.

Pre-Configured PB Channel Methods

In some embodiments, each VA associated with a given residence is pre-configured with a default unique PB channel. A VA can forego being assigned a channel upon approach (e.g., through any of the above methods). In some embodiments, a VA that is not initially associated with a residence (e.g., a visitor to a house) may use one or more of the methods described above to connect to an available GA.

Benefits of the VA-GA Connection Methods and Systems

Some of the benefits of the above-described features for mitigating cross-connect issues include the following:

In one or more of the example systems and methods, positioning data can be streamed over UDP from GA to VA. This may increase efficiency in connecting an approaching VA to a GA. For instance, positioning data streamed over UDP instead of being requested by a VA using the SAE J2847/6 protocol can minimize or avoid timing delays introduced by the request-response format and TCP retransmissions.

In one or more of the example systems and methods, the GAs that are in communication with respective VAs may remain connected to the Wi-Fi network 204 continuously, periodically, or as desired. This can be beneficial for maintaining connectivity to a remote computer network or system (e.g., a cloud-based service).

In one or more of the example systems and methods, the GA AP remains active but hidden, thereby taking advantage of the simultaneous AP/STA mode on the GA. This may have the benefit of increasing efficiency in the sequence of connecting the VA to the GA so that the GA does not have to wait to start its hidden AP until the VA is aligned and parked over the GA. Other benefits may include that other devices may be able to connect to the GA, via its hidden AP, for servicing, diagnostic, or configuration purposes as needed. The hidden AP can reduce the risk of a cyberattack by limiting the network interface's availability. Further, the use of standard WPA2/3 encryption can reduce the vulnerability within the home charging environment.

User Interface Considerations of VA-to-GA Connection Methods

The table below provides example user interface features for one or more of the VA-to-GA connection methods described herein, including automatic connection, in which the driver can select a parking space having a GA.

TABLE 1
Example user interface features of various connection methods.

| | |
|---|---|
| Feature | Automatic Connection, Driver's Choice of |
| Description | Parking Space |
| Wi-Fi | VA can be pre-configured to automatically connect |
| Connection | to the home Wi-Fi network when the VA comes within |
| Trigger | Wi-Fi range. |
| Parking | Driver can park over any available GA of his/her |
| Implications | choice. GA and VA can pair automatically (e.g., |
| | using one or more methods described herein). |
| Potential | No or low user intervention, just park and pair |
| UX Impact | automatically. |

Other Claims

In addition to the claims set forth below, the applicant believes that the following statement of the invention may be made:

A method for pairing a wireless power receiver to a wireless power transmitter, the wireless power receiver configured to charge a battery of a vehicle, the method comprising: joining, by the wireless power receiver, to a wireless network provided by a network device; transmitting, by the wireless power receiver over the wireless network, a message to a primary wireless power transmitter, wherein the primary wireless power transmitter is in communication with at least one secondary wireless power transmitter; receiving, by the wireless power receiver from the primary wireless power transmitter, identification information of an available communication channel and a network identifier, wherein the network identifier is associated with an available one of a set of wireless power transmitters, the set comprising the primary wireless power transmitter and the at least one secondary wireless power transmitter; receiving, by the wireless power receiver over the wireless network, alignment information from the available wireless power transmitter associated with the network identifier; detecting that the vehicle has parked proximate to the available wireless power transmitter according to the alignment information; and establishing, by the wireless power receiver with the available wireless power transmitter, a connection based on the network identifier.

The method above wherein the transmitted message comprises a broadcast message. The method above wherein the transmitted message is a direct message to a specific device on the wireless network. The method above, wherein at least one other wireless power receiver is joined to the wireless network. The method above wherein the detecting is by the wireless power receiver or by a component coupled to the wireless power receiver. The method above further comprising disconnecting, by the wireless power receiver, from the wireless network.

A wireless power receiver configured to charge a battery of a vehicle, the wireless power receiver comprising: a network interface, and a processor; wherein the processor is configured to connect the wireless power receiver to a wireless power transmitter by: joining the network interface to a wireless network provided by a network device; transmitting, over the wireless network, a message to a primary wireless power transmitter, wherein the primary wireless power transmitter is in communication with at least one secondary wireless power transmitter; receiving, over the wireless network, from the primary wireless power transmitter, identification information of an available communication channel and a network identifier, wherein the network identifier is associated with an available one of a set of wireless power transmitters, the set comprising the primary wireless power transmitter and the at least one secondary wireless power transmitter; receiving, over the wireless network, alignment information from the available wireless power transmitter associated with the network identifier; detecting that the vehicle has parked proximate to the available wireless power transmitter according to the alignment information; and establishing a connection with the available wireless power transmitter, based on the network identifier.

The wireless power receiver above, wherein the transmitted message comprises a broadcast message. The wireless power receiver above, wherein the transmitted message comprises a direct message to a specific device on the wireless network. The wireless power receiver above, wherein the detecting is by a component coupled to the wireless power receiver. The wireless power receiver above, wherein the processor is further configured to disconnect the network interface from the wireless network.

A wireless power transmitter comprising: a network interface, and a processor; wherein the processor is configured to connect the wireless power transmitter to a wireless power receiver to charge a battery of a vehicle by: joining the network interface to a wireless network provided by a network device; establishing communication with at least one secondary wireless power transmitter over the wireless network; receiving, over the wireless network, a message from the wireless power receiver; transmitting, over the wireless network, to the wireless power receiver, identification information of an available communication channel and a network identifier, wherein the network identifier is associated with an available one of a set of wireless power transmitters, the set comprising the wireless power transmitter and the at least one secondary wireless power transmitter; when the wireless transmitter is the available wireless power transmitter, transmitting to the wireless power receiver, over the wireless network, alignment information to enable the wireless power receiver to detect that the vehicle has parked proximate to the wireless power transmitter; and establishing a connection with the wireless power receiver, based on the network identifier.

The wireless power transmitter above, wherein the received message comprises a broadcast message. The wireless power transmitter above, wherein the received message comprises a direct message addressed to the wireless power transmitter. The wireless power transmitter above, wherein the processor is further configured to disconnect the network interface from the wireless network.

A method for pairing a wireless power receiver to a wireless power transmitter, the wireless power receiver configured to charge a battery of a vehicle, the method comprising: joining, by the wireless power receiver, to a wireless network provided by a network device; transmitting, by the wireless power receiver over the wireless network, a message to a primary wireless power transmitter, wherein the primary wireless transmitter is in communication with at least one secondary wireless power transmitter; receiving, by the wireless power receiver from the primary wireless power transmitter, identification information of an available communication channel; receiving, by the wireless power receiver over wireless network, alignment information from an available one of a set of wireless power transmitters, the set comprising the primary wireless power transmitter and the at least one secondary wireless power transmitter; detecting that the vehicle has parked proximate to the available wireless power transmitter according to the alignment information; transmitting, by the wireless power receiver, a request to connect to the available wireless power transmitter; receiving, by the wireless power receiver, a message from the available wireless power transmitter, the message comprising a network identifier; and establishing, by the wireless power receiver with the available wireless power transmitter, a connection based on the network identifier.

A wireless power receiver configured to charge a battery of a vehicle, the wireless power receiver comprising: a network interface, and a processor; wherein the processor is configured to connect the wireless power receiver to a wireless power transmitter by: joining the network interface to a wireless network provided by a network device; transmitting, over the wireless network, a message to a primary wireless power transmitter, wherein the primary wireless transmitter is in communication with at least one secondary wireless power transmitter; receiving, over the wireless network, from the primary wireless power transmitter, identification information of an available communication channel; receiving, over wireless network, alignment information from an available one of a set of wireless power transmitters, the set comprising the primary wireless power transmitter and the at least one secondary wireless power transmitter; detecting that the vehicle has parked proximate to the available wireless power transmitter according to the alignment information; transmitting, over the wireless network, a request to connect to the available wireless power transmitter; receiving, over the wireless network, a message from the available wireless power transmitter, the message comprising a network identifier; and establishing a connection with the available wireless power transmitter, based on the network identifier.

A wireless power transmitter comprising: a network interface, and a processor; wherein the processor is configured to connect the wireless power transmitter to a wireless power receiver configured to charge a battery of a vehicle by: joining the network interface to a wireless network provided by a network device; establishing communication with at least one secondary wireless power transmitter over the wireless network; receiving, over the wireless network, a message from the wireless power receiver; transmitting, over the wireless network, identification information of an available communication channel; when the wireless transmitter is an available wireless power transmitter, transmitting, over wireless network, alignment information to enable the wireless power receiver to detect that the vehicle has parked proximate to the wireless power transmitter; receiving, over the wireless network, a request from the wireless power receiver to connect to the wireless power transmitter; transmitting, over the wireless network, a message comprising a network identifier; and establishing a connection with the wireless power receiver, based on the network identifier.

A method for pairing a wireless power receiver to a wireless power transmitter, the wireless power receiver configured to charge a battery of a vehicle, the method comprising: joining, by the wireless power receiver, to a wireless network provided by a network device; transmitting, by the wireless power receiver over the wireless network, a broadcast message to a set of wireless power devices, the set including at least two wireless power transmitters; selecting, by the wireless power receiver, an available communication channel of one or more available communication channels; receiving, by the wireless power receiver over the wireless network, alignment information from an available wireless power transmitter of the set of wireless power devices; detecting that the vehicle has parked proximate to the available wireless power transmitter according to the alignment information; transmitting, by the wireless power receiver, a request to connect to the available wireless power transmitter; receiving, by the wireless power receiver, a message from the available wireless power transmitter, the message comprising a network identifier; and establishing, by the wireless power receiver with the available wireless power transmitter, a connection based on the network identifier.

The method above wherein the set comprises at least one other wireless power receiver in communication with one of the at least two wireless power transmitters, and wherein the method further comprises: receiving, by the wireless power receiver, identification information of one or more communication channels in use by the other wireless power receiver.

A wireless power receiver configured to charge a battery of a vehicle, the wireless power receiver comprising: a network interface, and a processor; wherein the processor is configured to connect the wireless power receiver to a wireless power transmitter by joining the network interface to a wireless network provided by a network device; transmitting, over the wireless network, a broadcast message to a set of wireless power devices, the set including at least two wireless power transmitters; selecting an available communication channel of one or more available communication channels; receiving, over the wireless network, alignment information from an available wireless power transmitter of the set of wireless power devices; detecting that the vehicle has parked proximate to the available wireless power transmitter according to the alignment information; transmitting, over the wireless network, a request to connect to the available wireless power transmitter; receiving, over the wireless network, a message from the available wireless power transmitter, the message comprising a network identifier; and establishing a connection with the available wireless power transmitter, based on the network identifier.

The wireless power receiver above wherein the set of wireless power device comprises at least one other wireless power receiver in communication with one of the at least two wireless power transmitters, and wherein the processor is further configured to receive, over the wireless network, identification information of one or more communication channels in use by the other wireless power receiver.

Hardware and Software Implementations

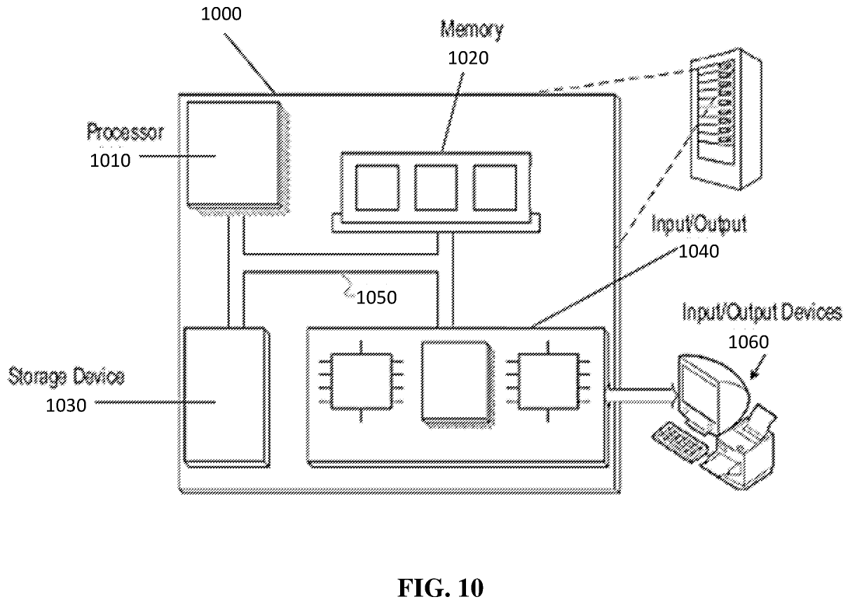

FIG. 10 is a block diagram of an example computer system 1000 that may be used in implementing the systems and methods described herein. General-purpose computers, network appliances, mobile devices, or other electronic systems may also include at least portions of the system 1000. The system 1000 includes a processor 1010, a memory 1020, a storage device 1030, and an input/output device 1040. Each of the components 1010, 1020, 1030, and 1040 may be interconnected, for example, using a system bus 1050. The processor 1010 is capable of processing instructions for execution within the system 1000. In some implementations, the processor 1010 is a single-threaded processor. In some implementations, the processor 1010 is a multi-threaded processor. The processor 1010 is capable of processing instructions stored in the memory 1020 or on the storage device 1030.

The memory 1020 stores information within the system 1000. In some implementations, the memory 1020 is a non-transitory computer-readable medium. In some implementations, the memory 1020 is a volatile memory unit. In some implementations, the memory 1020 is a non-volatile memory unit. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

The storage device 1030 is capable of providing mass storage for the system 1000. In some implementations, the storage device 1030 is a non-transitory computer-readable medium. In various different implementations, the storage device 1030 may include, for example, a hard disk device, an optical disk device, a solid-date drive, a flash drive, or some other large capacity storage device. For example, the storage device may store long-term data (e.g., database data, file system data, etc.). The input/output device 1040 provides input/output operations for the system 1000. In some implementations, the input/output device 1040 may include one or more of a network interface devices, e.g., an Ethernet card, a serial communication device, e.g., an RS-232 port, or a wireless interface device, e.g., an 802.11 card, or a wireless modem. In some implementations, the input/output device may include driver devices configured to receive input data and send output data to other input/output devices, e.g., keyboard, printer and display devices 1060. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1030 may be implemented in a distributed way over a network, such as a server farm or a set of widely distributed servers, or may be implemented in a single computing device.

Although an example processing system has been described in FIG. 10, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single product or packaged into multiple products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A method for pairing a wireless power receiver to a wireless power transmitter, the wireless power receiver configured to charge a battery of a vehicle, the method comprising:
joining, by the wireless power receiver, to a wireless network provided by a network device;
transmitting, by the wireless power receiver over the wireless network, a first message to a first wireless power transmitter;
receiving, by the wireless power receiver over the wireless network, a network identifier;
selecting, by the wireless power receiver, an available communication channel of one or more available communication channels;
receiving, by the wireless power receiver over the wireless network, alignment information from an available one of a set of wireless power transmitters, the set comprising the first wireless power transmitter and at least a second wireless power transmitter;
detecting that the vehicle has parked proximate to the available wireless power transmitter according to the alignment information; and
establishing, by the wireless power receiver with the available wireless power transmitter, a connection based on the network identifier.

2. The method of claim 1, wherein the network identifier is associated with the available wireless power transmitter.

3. The method of claim 1, wherein the network identifier is received from the available wireless power transmitter.

4. The method of claim 1, wherein the first message is transmitted to the first wireless power transmitter, wherein the first wireless power transmitter is in communication with at least the second wireless power transmitter.

5. The method of claim 4, wherein the network identifier is received from the first wireless power transmitter.

6. The method of claim 1, wherein the network identifier comprises a Service Set Identifier (SSID).

7. The method of claim 1, wherein the network identifier comprises a Basic Service Set Identifier (BSSID).

8. The method of claim 1, wherein selecting the available communication channel comprises receiving, by the wireless power receiver over the wireless network, identification information of the available communication channel.

9. The method of claim 8, wherein the first message is transmitted to the first wireless power transmitter, wherein the first wireless power transmitter is in communication with at least the second wireless power transmitter, and
the identification information of the available communication channel is received from the first wireless power transmitter.

10. The method of claim 1, further comprising transmitting, by the wireless power receiver, a request to connect to the available wireless power transmitter.

11. The method of claim 1, wherein the first message is a broadcast message to a set of wireless power devices, the set including at least the first and second wireless power transmitters.

12. The method of claim 11, wherein the set of wireless power devices comprises at least one other wireless power receiver in communication with one of the at least two wireless power transmitters, and wherein the method further comprises:
receiving, by the wireless power receiver, identification information of one or more communication channels in use by the other wireless power receiver.

13. The method of claim 1, wherein the first message is a broadcast message.

14. The method of claim 1, wherein the transmitted message is a direct message to a specific device on the wireless network.

15. The method of claim 1, wherein at least one other wireless power receiver is joined to the wireless network.

16. The method of claim 1, wherein the detecting is by the wireless power receiver or by a component coupled to the wireless power receiver.

17. The method of claim 1, further comprising disconnecting, by the wireless power receiver, from the wireless network.

18. The method of claim 1, wherein the network device comprises a router associated with a residence.

19. The method of claim 17, wherein the network device further comprises a Wi-Fi access point.

20. The method of claim 17, wherein the network device further comprises an LTE modem.

21. A wireless power receiver configured to charge a battery of a vehicle, the wireless power receiver comprising:
a network interface, and
a processor; wherein the processor is configured to connect the wireless power receiver to a wireless power transmitter by:
joining the network interface to a wireless network provided by a network device;
transmitting, over the wireless network, a first message to a first wireless power transmitter;
receiving, over the wireless network, a network identifier;
selecting an available communication channel of one or more available communication channels;
receiving, over the wireless network, alignment information from an available one of a set of wireless power transmitters, the set comprising the first wireless power transmitter and a at least a second wireless power transmitter;
detecting that the vehicle has parked proximate to the available wireless power transmitter according to the alignment information; and
establishing, with the available wireless power transmitter, a connection based on the network identifier.

22. The wireless power receiver of claim 21, wherein the network identifier is associated with the available wireless power transmitter.

23. The wireless power receiver of claim 21, wherein the processor is further configured to receive the network identifier from the available wireless power transmitter.

24. The wireless power receiver of claim 21, wherein the processor is configured to select the available communication channel by receiving, over the wireless network, identification information of the available communication channel.

25. The wireless power receiver of claim 21, wherein the processor is further configured to transmit a request to connect to the available wireless power transmitter.

26. The wireless power receiver of claim 21, wherein the processor is further configured to broadcast the first message to a set of wireless power devices, the set including at least the first and second wireless power transmitters.

27. The wireless power receiver of claim 26, where the processor is further configured to receive identification information of one or more communication channels in use by one other wireless power receiver in communication with one of the at least two wireless power transmitters.

28. The wireless power receiver of claim 21, wherein the first message is a broadcast message.

29. The wireless power receiver of claim 21, wherein the transmitted message is a direct message to a specific device on the wireless network.

30. The wireless power receiver of claim 21, wherein the processor is further configured to disconnect the network interface from the wireless network.

31. A wireless power transmitter comprising:
a network interface, and
a processor; wherein the processor is configured to connect the wireless power transmitter to a wireless power receiver configured to charge a battery of a vehicle by:
joining the network interface to a wireless network provided by a network device;
establishing communication with at least one secondary wireless power transmitter over the wireless network;
receiving, over the wireless network, a first message from a first wireless power receiver;
transmitting, over the wireless network, a network identifier to the wireless power receiver;
when the wireless transmitter is an available wireless power transmitter, transmitting, over wireless network, alignment information to enable the wireless power receiver to detect that the vehicle has parked proximate to the wireless power transmitter; and
establishing, with the wireless power receiver, a connection based on the network identifier.

32. The wireless power transmitter of claim 21, wherein the network identifier is associated with the available wireless power transmitter.

33. The wireless power transmitter of claim 21, wherein the processor is configured to transmit identification information of an available communication channel to the first wireless power receiver.

34. The wireless power transmitter of claim 21, wherein the processor is further configured to receive a request to connect to the wireless power transmitter.

35. The wireless power transmitter of claim 21, wherein the processor is further configured to receive the first message as message broadcast to a set of wireless power devices, the set including at least the wireless power transmitter and a second wireless power transmitter.

36. The wireless power receiver of claim 35, where the processor is further configured to transmit, to the wireless power receiver, identification information of one or more communication channels in use by one other wireless power receiver in communication with one of set of wireless power transmitters.
